(19) United States
(12) Patent Application Publication
(10) Pub. No.: US 2005/0215661 A1
(43) Pub. Date: Sep. 29, 2005

(54) NBC-resistant composition

(75) Inventor: Krishnakant P. Vora, Round Rock, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/806,842

(22) Filed: Mar. 23, 2004

(51) Int. Cl. C08K 3/26; C08K 3/34; C08J 3/00

(52) U.S. Cl. 523/122; 524/492; 524/445

(57) ABSTRACT

A composition including a terpolymer of an ethylene-propylene-diene monomer, a flame retardant, and an antimicrobial agent.

### CROSS-REFERENCE TO RELATED APPLICATION(S)

The co-pending patent application filed on even date (attorney docket 59575US002), entitled “Cold-Shrink Marker Sleeve”, is incorporated herein by reference in its entirety.

### FIELD OF THE INVENTION

The present invention relates to compositions for use in hazardous environments. In particular, the present invention relates to compositions that exhibit elastomeric properties and are resistant to hazardous environments containing nuclear, biological, or chemical agents.

### BACKGROUND OF THE INVENTION

Articles used in hazardous environments may be subjected to a variety of destructive agents, such as nuclear, biological, and chemical (NBC) agents. Such environments may typically occur in military applications, where warfare may expose such articles to a variety of NBC agents. Other applications may include industrial processing, chemical plants, nuclear reactors, and biohazardous industries. The articles used in these applications must be NBC resistant to provide continuing use over the long term despite being exposed to the NBC agents.

Nuclear agents generally include radiation and heat emissions, such as emissions from nuclear reactions or exposure to extreme heat and sun conditions. Biological agents generally refer to biological organisms, such as viruses, bacteria, and fungi; and biochemical agents. Chemical agents generally refer to agents that damage articles via chemical reactions, toxicity enhancement, and chemical removal (e.g., extraction). Common chemical agents include solvents, corrosive materials, oxidizing agents, and highly toxic organic agents.

In addition to damaging the articles, NBC agents may also remove identification markings located on articles. Identification markings are often applied to articles to serve a variety of informational purposes. For example, the markings may provide information regarding product names, manufacturer names, bar codes, serial numbers, batch numbers, and expiration dates. In order to serve such purposes, it is desirable that the marks be visually legible and durable. Exposing articles that are not resistant to such hazardous environments, however, potentially damages the articles and may remove the identification markings. As such, there is a need for a composition that is resistant to NBC agents, which may be used to create articles that are correspondingly resistant to NBC agents.

### BRIEF SUMMARY OF THE INVENTION

The present invention relates to a composition that includes a terpolymer of an ethylene-propylene-diene monomer (EPDM), a flame retardant, and an antimicrobial agent. The composition is resistant to NBC agents and may be used to create articles that are used in hazardous environments that contain NBC agents.

The present invention further relates to an article that includes a mixture of a terpolymer of an EPDM, a flame retardant, and an antimicrobial agent. The article also includes focused energy beam-induced indicia located on a surface of the article. The indicia may provide information for a variety of purposes, and is visually legible and durable for use in hazardous environments that contain NBC agents.

### BRIEF DESCRIPTION OF THE DRAWINGS

FIG. 1 is a perspective view of an article of the present invention in use with a cable.

FIG. 2 is a perspective view of an article of the present invention in a relaxed state.

FIG. 3 is a perspective view of an article of the present invention in an expanded state on a core.

FIG. 4 is another perspective view of an article of the present invention in an expanded state on a core.

FIG. 5 is a perspective view of a marked article of the present invention in an expanded state on a core in association with a cable.

FIG. 6 is a perspective view of an article of the present invention that is partially located on a core and partially located on a cable.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

The present invention encompasses a composition that is resistant to NBC agents and includes a terpolymer of an EPDM, a flame retardant, and an antimicrobial agent. The composition may be used to create articles that are correspondingly NBC resistant, for use in hazardous environments. Generally, it is desirable that such articles prevent entrapment of liquid and invasive powdered agents, such as corrosive materials, highly toxic organic agents, and biochemical agents. Similarly, it is desirable that the articles be resistant to chemical attack, such as exposure to liquids and vapors of gasoline, hydraulic fluid, and solvents. Resistance to such agents reduces or eliminates degradation of the articles, which correspondingly provides longer product lives.

Terpolymers of an EPDM, referred to herein as “EPDM rubbers”, exhibit good resistance to heat, ozone, oxidation, weathering, and polar solvents. Examples of suitable diene termonomers used to form EPDM rubbers include ethylidene norbomene and dicyclopentadiene. The EPDM rubbers also provide elastomeric properties to articles created from the composition of the present invention. The elastomeric properties allow the articles to expand and shrink to conform to accompanying components. For example, the composition of the present invention is useful to create sleeve articles, which may be expanded to fit around cables, wires, and other transmission and distribution runs, such as fluid hoses and pipes.

Flame retardants provide resistance to heat and fire, which may be common in many industrial and military applications. Examples of suitable fire retardants include the following, which are commercially available from Albemarle Corporation of Houston, Tex.: Decabromodiphenyl oxide (e.g. “Saytex 102E”); tetradecabromodiphenoxy benzene (e.g. “Saytex 120”); 1,2-bis(pentabromophenyl) ethane (e.g. “Saytex 8010”); 1,2 bis(tetrabromophthalimide) ethane (e.g. “Saytex BT-93” and “Saytex BT-93W”); tetrabromobisphenol A (e.g. “Saytex CP-2000”); hexabromocyclododecane (e.g. “Saytex HP-900” and “Saytex 9006L”); brominated polystyrene (e.g. “Saytex HP-7010 P/G” and “Saytex HP-3010”); and combinations thereof.

In addition to flame retardants, flame retardant synergists may also be incorporated into the composition of the present invention to assist the flame retardants. Examples of suitable flame retardant synergists include antimony compounds, such as antimony trioxide (commercially available from Albemarle Corp. under the trade designation “Saytex FS-100”), antimony pentoxide, and sodium antimonite (commercially available from Nyacol Nano Technologies, Inc. of Ashland, Mass. under the trade designation “Nycol Bum EX ZTA”), and combinations thereof.

Antimicrobial agents incorporated in the composition of the present invention are desirably broad spectrum antimicrobial agents, which provide protection against a wide range of biological agents. Examples of suitable antimicrobial agents include fungicides, algaecides, antifouling agents, bactericides, and combinations thereof. Fungicides and algaecides include agents that prevent the growth of fungi, algae, mildew, yeast, mold, and the like. Examples of suitable fungicides and algaecides include zinc complexes of pyrithione (e.g., 2-pyridinethiol-1-oxide, zinc complex), (e.g. “Zinc Omadine”), sodium complexes of pyrithione (e.g., 2-pyridinethiol-1-oxide, sodium salt), (e.g. “Sodium Omadine”), iodopropynyl butyl carbamate compounds (e.g., 3-iodopropynylbutylcarbamate), (e.g. “Omacide IPBC”), all commercially available from Arch Chemicals, Inc. of Cheshire, Connecticut, and combinations thereof. Antifouling agents are similar to fungicides and algaecides and are designed for marine use. Examples of suitable antifouling agents include copper complexes of pyrithione (e.g. “Copper Omadine”), which are commercially available from Arch Chemicals, Inc. Bactericides are antibacterial agents preferably effective against both Gram positive and Gram negative bacteria. Examples of suitable bactericides include Hexahydro-1,3,5-tris(2-hydroxyethyl)-s-triazine and 1,3,5-triazine-1,3,5-(2H, 4H, 6H)-triethanol (e.g. “Triadine”), which are commercially available from Arch Chemicals, Inc.

All concentrations herein are expressed in weight percent, unless otherwise stated. Suitable component concentrations in the composition of the present invention range from about 10.0% to about 95.0% of the EPDM rubber, from about 10.0% to about 50.0% of the flame retardant, and from about 0.05% to about 1.0% of the antimicrobial agent, based on the total compositional weight of the composition of the present invention. Particularly suitable component concentrations in the composition of the present invention range from about 30.0% to about 80.0% of the EPDM rubber, from about 10.0% to about 30.0% of the flame retardant, and from about 0.1% to about 0.4% of the antimicrobial agent, based on the total compositional weight of the composition of the present invention. For a composition of the present invention that includes a flame retardant synergist, suitable concentrations of the flame retardant synergist in the composition of the present invention range from about 1.0% to about 10.0%, with particularly suitable concentrations of the flame retardant synergist in the composition of the present invention ranging from about 1.0% to about 4.0%, based on the total compositional weight of the composition of the present invention.

The composition of the present invention may also include additional materials such as pigments, antioxidants, stabilizing agents, oils, processing aids, fillers, cross-linking materials, and acrylic co-agents.

Examples of suitable pigments include titanium dioxide; carbon black; zinc oxide; pression blue; cadimum sulfide; iron oxide; chromates of lead, zinc, barium, and calcium; azo; thioindigo; anthraquinone; anthoanthrone; triphenonedioxazine; fat dye pigments; phthalocyanine pigments, such as copper phthalocyanine pigment and its derivatives; quinacridon pigment; pigments commercially available under the trade designations “Cinquasia”, “Cromophtal”, “Filamid”, “Filester”, “Filofin”, “Homachrome”, “Homa Molybdate”, “Homatherm”, “Irgacolor”, “Irgalite”, “Irgasperse”, “Irgazin”, “Micranyl”, “Microlen”, “Microlith”, “Microsol”, and “Unisperse”, all from Ciba Specialty Chemicals, Tarrytown, N.Y.; and combinations thereof. Suitable concentrations of the pigments in the composition of the present invention include from about 0.1% to about 10.0%, with particularly suitable concentrations of the pigments in the composition of the present invention including from about 1.0% to about 5.0%, based upon the total compositional weight of the composition of the present invention.

Examples of suitable antioxidants include solutions of zinc 2-mercaptotoluimidazole in petroleum process oil (e.g., “Vanox ZMTI” and “Vanox MTI”) and mixtures of octylated diphenylamines (e.g. “Agerite Stalite”), all commercially available from R.T. Vanderbilt Company, Inc. of Norwalk, Conn.; and combinations thereof. Suitable concentrations of the antioxidants in the composition of the present invention range from about 0.1% to about 5.0%, with particularly suitable concentrations of the antioxidants in the composition of the present invention ranging from about 0.5% to about 1.5%, based on the total compositional weight of the composition of the present invention.

Examples of suitable oils include hydrocarbon oils, mineral oils, pine oils, paraffinic petroleum oils, oleic acid, glycerol, polypropylene glycols, polybutylene glycols, and combinations thereof. Suitable concentrations of the oils in the composition of the present invention range from about 5.0% to about 40.0%, with particularly suitable concentrations of the oils in the composition of the present invention ranging from about 10.0% to about 25.0%, based on the total compositional weight of the composition of the present invention.

Examples of suitable processing aids include the following, which are commercially available from Struktol Company of America of Stow, Ohio: Mixtures of fatty acid metal (e.g., zinc) soaps and amides (e.g., “Struktol A 50”, “Struktol A 60”, “Struktol A 61”, “Struktol EF 44 A”, and “Struktol WB 42”); mixtures of rubber compatible non-hardening fatty acid soaps (e.g., “Struktol EP 52”); fatty acid esters and soaps-bound fillers (e.g., “Struktol W 34” and “Struktol” WB 212”); mixtures of lubricants and fatty acid derivatives (e.g., “Struktol W 80”); mixtures of esters and zinc soaps of fatty acids (e.g., “Struktol WA 48”); mixtures of fatty acid soaps, predominantly calcium (e.g., “Struktol WB 16”); mixtures aliphatic fatty acid esters and condensation products (e.g., “Struktol WB 222”); condensation products of fatty acid derivatives and silicones (e.g., “Struktol WS 180”); organosilicone compounds on inorganic carriers (e.g., “Struktol WS 280”); and combinations thereof. Suitable concentrations of the processing aids in the composition of the present invention range from about 0.1% to about 10.0%, with particularly suitable concentrations of the processing aids in the composition of the present invention ranging from about 0.5% to about 2.0%, based on the total compositional weight of the composition of the present invention.

Fillers may be incorporated in the composition of the present invention to enhance physical and rheological properties. Examples of suitable fillers include clay fillers, hydrated amorphous silica, precipitated silica, fumed silica, fired silica, hydrophobized silica, derivatives thereof, and combinations thereof. Examples of suitable clay fillers include silane treated kaolin clay (aluminum silicate) fillers commercially available from Engelhard Corporation of Iselin, New Jersey under the trade designations “Translink 37”, “Translink 77”, “Translink 445”, “Translink 555”, and “Translink HF-900”. Suitable concentrations of the fillers in the composition of the present invention range from about 1.0% to about 50.0%, with particularly suitable concentrations of the fillers in the composition of the present invention ranging from about 10.0% to about 25.0%, based on the total compositional weight of the composition of the present invention.

Silane coupling agents assist in bonding the fillers to the polymers of the composition of the present invention. Examples of suitable silane coupling agents include vinyl silanes (e.g., “A-172 DLC”), methacryl silanes (e.g., “A-174 DLC”), amino silanes (e.g., “A-1100 DLC” and “A-1120”), all commercially available from Natrochem, Inc. of Savannah, Georgia; liquid tetrasulfide silanes (e.g., “Silquest A-1289”), liquid disulfide silanes (e.g., “Silquest A-1589”), both commercially available from OSI Specialties Division of Witco Corporation of Danbury, Connecticut; and combinations thereof. Suitable concentrations of the silane coupling agents in the composition of the present invention range from about 0.1% to about 5.0%, with particularly suitable concentrations of the silane coupling agents in the composition of the present invention ranging from about 0.1% to about 1.0%, based on the total compositional weight of the composition of the present invention.

Examples of suitable cross-linking agents include amines and peroxides, such as the following peroxides that are commercially available from R.T. Vanderbilt Company, Inc. of Norwalk, Conn.: Dicumyl peroxide (e.g., “Varox DCP”, “Varox DCP-40C”, “Varox DCP-40KE”, and “Varox DCP-40KE-HP”); benzoyl peroxide (e.g., “Varox ANS”); dibenzoyl peroxide (e.g., “Varox A 75”); 2,5-dimethyl-2,5-di(t-butylperoxy) hexane (e.g., “Varox DBPH”, “Varox DBPH 40 MB”, “Varox DBPH-50”, “Varox DBPH-50-HP”, “Varox DBPH-P20”, and “Varox DCP-40KE”); t-butyl perbenzoate (e.g., “Varox TBPB” and “Varox TBPB-50”); 2,5-dimethyl-2,5-di(t-butylperoxy) hexyne-3 (e.g., “Varox 130” and “Varox 130-XL”); alpha, alpha-bis(t-butylperoxy)diisopropylbenzene (e.g., “Varox VC-R”); di-(2-tert-butylperoxyisopropyl) benzene (e.g., “Varox 802-40C”, “Varox 802-40KE”, and “Varox 802-40KE-HP”); di-(2-tert-butylperoxyisopropyl) benzene in EPR (e.g., “Varox 802-40MB”); derivatives thereof; and combinations thereof. Suitable concentrations of the cross-linking agents in the composition of the present invention range from about 0.5% to about 5.0%, with particularly suitable concentrations of the cross-linking agents in the composition of the present invention ranging from about 1.0% to about 3.0%, based on the total compositional weight of the composition of the present invention.

Acrylic co-agents may be incorporated into the composition of the present invention to enhance the cross-linking reaction. Examples of suitable acrylic co-agents include multi-functional monomers, such as difunctional and trifunctional monomers. Examples of suitable difunctional monomers include the following, which are commercially available from Sartomer Company, Inc., Exton, Pa.: 1,3-butylene glycol diacrylate,1,3-butylene glycol dimethacrylate, 1,4-butanediol diacrylate, 1,4-butanediol dimethacrylate, 1,6 hexanediol diacrylate, 1,6 hexanediol dimethacrylate, aliphatic dimethacrylate monomer, alkoxylated aliphatic diacrylate, alkoxylated cyclohexane dimethanol diacrylate, alkoxylated cyclohexane dimethanol diacrylate, alkoxylated cyclohexane dimethanol diacrylate, alkoxylated hexanediol diacrylate, alkoxylated hexanediol diacrylate, alkoxylated hexanediol diacrylate, alkoxylated neopentyl glycol diacrylate, alkoxylated neopentyl glycol diacrylate, aromatic dimethacrylate monomer, caprolactione modified neopentylglycol hydroxypivalate diacrylate, caprolactone modified neopentylglycol hydroxypivalate diacrylate, cyclohexane dimethanol diacrylate, cyclohexane dimethanol dimethacrylate, diethylene glycol diacrylate, diethylene glycol dimethacrylate, dipropylene glycol diacrylate, ethoxylated (10) bisphenol alpha diacrylate, ethoxylated (2) bisphenol alpha dimethacrylate, ethoxylated (3) bisphenol alpha diacrylate, ethoxylated (30) bisphenol alpha diacrylate, ethoxylated (30) bisphenol alpha dimethacrylate, ethoxylated (4) bisphenol alpha diacrylate, ethoxylated (4) bisphenol alpha dimethacrylate, ethoxylated (8) bisphenol alpha dimethacrylate, ethoxylated bisphenol alpha dimethacrylate, ethoxylated bisphenol alpha dimethacrylate, ethoxylated(10) bisphenol dimethacrylate, ethoxylated(6) bisphenol alpha dimethacrylate, ethylene glycol dimethacrylate, hydroxypivalaldehyde modified trimethylolpropane diacrylate, neopentyl glycol diacrylate, neopentyl glycol dimethacrylate, polyethylene glycol (200) diacrylate, polyethylene glycol (400) diacrylate, polyethylene glycol (400) dimethacrylate, polyethylene glycol (600) diacrylate, polyethylene glycol (600) dimethacrylate, polyethylene glycol dimethacrylate, polypropylene glycol (400) dimethacrylate, propoxylated (2) neopentyl glycol diacrylate, tetraethylene glycol diacrylate, tetraethylene glycol dimethacrylate, tricyclodecane dimethanol diacrylate, triethylene glycol diacrylate, triethylene glycol dimethacrylate, tripropylene glycol diacrylate, tripropylene glycol diacrylate, and combinations thereof.

Suitable concentrations of the acrylic co-agents in the composition of the present invention range from about 0.1% to about 5.0%, with particularly suitable concentrations of the acrylic co-agents in the composition of the present invention ranging from about 0.5% to about 2.0%, based on the total compositional weight of the composition of the present invention.

The composition of the present invention may be prepared by combining the EPDM rubber, the flame retardant, and the antioxidant, and then mixing the components in a 10D 2-wing tangential Banbury mixer with a 220 liter capacity at about 50 rotations-per-minute for about 4-8 minutes at temperature of about 141° C. The Banbury mixer is commercially available from Farrel Corporation of Ansonia, Connecticut. The mixed composition may then be passed through a 25.4-cm extruder equipped with a 100 mesh screen to remove undispersed particles.

Additional materials such as pigments, antioxidants, oils, processing aids, neutralizers, rheology modifiers, fillers, and silane coupling agents, may also be added to the EPDM rubber, the flame retardant, and the antioxidant prior to mixing. However, if cross-linking agents or acrylic co-agents are to be incorporated in the composition, the addition of these components should be in a second mixing step at a lower temperature to prevent premature crosslinking. After the EPDM rubber, the flame retardant, and the antimicrobial agent have been combined, mixed, and passed through the mesh screen, the cross-linking agents and acrylic co-agents may be added and the overall composition may be mixed with a 10D 2-wing tangential Banbury mixer with a 220 liter capacity at about 45 rotations-per-minute for about 1.5-3 minutes at temperature of about 102° C.

The composition of the present invention may be used to create a variety of articles that are resistant to NBC agents. Suitable articles created from the composition of the present invention may include marker sleeves, tubing, polymeric sheets, protective layers, containers, and the like. The articles may be formed by a variety of procedures, such as single screw, twin screw, or other extruder systems. A suitable extruder includes a 5.1-cm single-screw extruder with a length-to-diameter ratio of about 15. Suitable operation conditions for the extruder include extruder zone temperatures and a die temperature of about 80° C., and a rotation rate of about 20 to about 40 rotations-per-minute. This provides for a material flow rate of about 3-12 meters-per-minute. Particular pins and dies will dictate inner diameters and layer thicknesses of the article prior to crosslinking. Upon exiting the extruder, the article may be passed through an autoclave to crosslink the components of the composition to form the article. Suitable autoclave conditions include subjecting the article to a steam pressure of about 620 kilopascals for about 45 minutes, which is equivalent to exposure to a temperature of about 166° C. at atompshereic pressure for about 45 minutes.

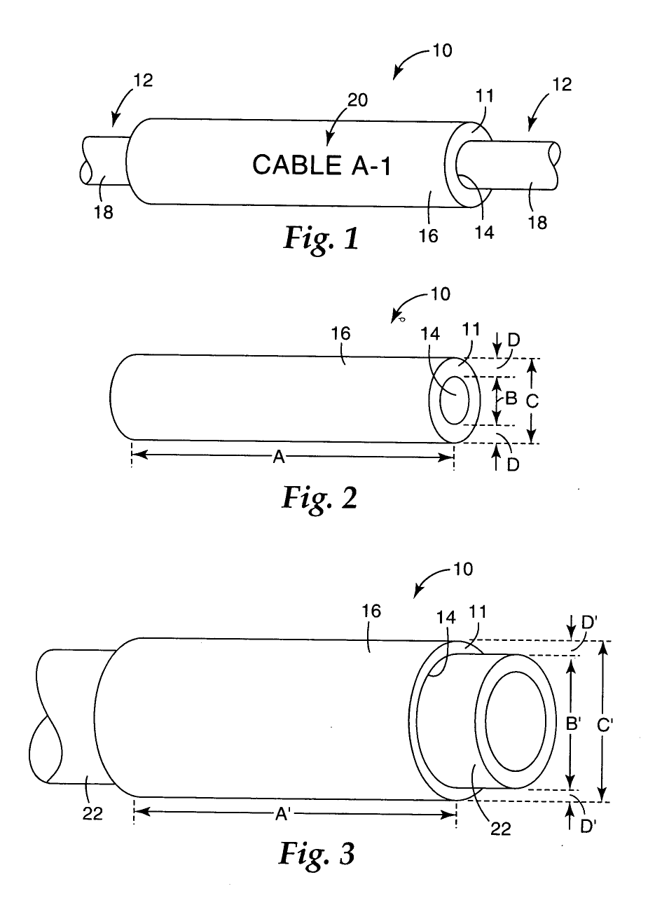

As previously discussed, the elastomeric properties of the EPDM rubber allow the articles to expand and shrink to conform to accompanying components. As such, the composition of the present invention is particularly suitable for creating expandable marker sleeves, such as a marker sleeve 10, as depicted in use on a cable 12 in FIG. 1.

The marker sleeve 10 is a tubular article that provides information for, or about, a transmission or distribution run, such as electric and telephone cables, wire, fluid-carrying piping, and conduits. The cable 12 is an example of such a transmission or distribution run, although the marker sleeve 10 may be used on any transmission or distribution run. The marker sleeve 10 is capable of providing the information even after being exposed to NBC agents.

As illustrated, the marker sleeve 10 includes a radial wall 11, an inner surface 14, and an outer surface 16, where the inner surface 14 extends around, faces, and is typically in contact with an outer surface 18 of the cable 12. Indicia 20, which is information marked by a focused energy beam, is located on the outer surface 16. A focused energy beam refers to a directionally focused emission of radiation, such as a laser beam. The indicia 20 may be a single mark or a plurality of marks, and may include a variety of textual (i.e., alphanumeric) or graphical characters, symbols, and the like. The indicia 20 may also be or include machine-readable indicia, such as bar codes. The indicia 20 may be formed by conventional laser marking techniques, or alternatively, the indicia 20 may be formed by a technique described in the co-pending patent application filed on even date (attorney docket 59575US002), entitled “Cold-Shrink Marker Sleeve”, and which is incorporated herein by reference in its entirety.

In this alternative, the indicia 20 is formed by expanding the marker sleeve 10 from a relaxed state, marking the outer surface 16 (in the expanded state) with a focused energy beam, and allowing the marked marker sleeve 10 to cold shrink back toward the relaxed state. The term “cold shrink” is referred to herein as the capability of the marker sleeve 10 to shrink from an expanded state toward a relaxed state at temperature less than about 50° C. As the marker sleeve 10 cold shrinks toward the relaxed state, the indicia 20 retain a high level of visual legibility. Moreover, the marker sleeve 10 may be used in hazardous environments that contain NBC agents so the indicia 20 substantially retain the high level of visual legibility.

While depicted in FIG. 1 as a single tubular article, the marker sleeve 10 of the present invention may include a variety of shaped features, such as multiple-branched tubular articles (i.e., multiple entrances and exits). The indicia 20 on the marker sleeve 10 as a multiple-branched tubular article may be formed by separately expanding, marking, and cold shrinking each branched portion.

The composition of the present invention may further include an energy beam absorber, such as a laser beam absorber. Suitable energy beam absorbers are disclosed in the co-pending patent application filed on even date (attorney docket 59575US002), entitled “Cold-Shrink Marker Sleeve”. Suitable concentrations of the energy beam absorber in the composition of the present invention include from about 0.01% to about 5.0% of the energy beam absorber, based upon the total compositional weight of the composition of the present invention. Particularly suitable concentrations of the energy beam absorber in the composition of the present invention include from about 0.01% to about 3.0% of the energy beam absorber, based upon the total compositional weight of the composition of the present invention.

The EPDM rubber, which exhibits elastomeric properties, allows the marker sleeve 10 to expand from the relaxed state to the expanded state without breakage or cracking, and also allows the marker sleeve 10 to cold shrink from the expanded state back toward the relaxed state. The pigment generally provides a base color of the marker sleeve 10, including a base color to the outer surface 16. Similarly, upon heating by a focused energy beam, the energy beam absorber generally provides a contrasting color to the indicia 20. For high visual legibility of the indicia 20, it is desirable to use a pigment and an energy beam absorber that provide a high contrast between the base color of the outer surface 16 and the contrasting color of the indicia 20. For example, a bright yellow or white color for the outer surface 16 may be suitable when the energy beam absorber provides a dark gray or black color for the indicia 20. Alternatively, a dark color for the outer surface 16 may be suitable if the energy beam absorber provides a light-color for the indicia 20. In either case, the high color contrast between the base color and the contrasting color increases the visual legibility of the indicia 20.

To form the marker sleeve 10 with the indicia 20 located on the outer surface 16, the composition of the present invention is mixed, extruded, and cross-linked, as previously discussed, to provide the marker sleeve 10 as depicted in FIG. 2. FIG. 2 is a perspective view of the marker sleeve 10 in a relaxed state prior to expansion and marking. When the marker sleeve 10 is in the relaxed state, the radial wall 11 has a longitudinal length A, an inner diameter B, an outer diameter C, and a layer thickness D. The longitudinal length A and the inner diameter B will vary based upon individual needs, such as the dimensions of the cable 12. The inner diameter B desirably is adequate to present a sealed fit around the surface 18 of the cable 12 to at least prevent the marker sleeve 10 from sliding along the cable 12.

The outer diameter C is generally determined by the inner diameter B and the layer thickness D, where the layer thickness D is substantially uniform around and along the marker sleeve 10. The layer thickness D is desirably thin enough to allow the marker sleeve 10 to readily expand from the relaxed state, while also thick enough so laser marking does not burn through the radial wall 11 of the marker sleeve 10, when the marker sleeve 10 is in the expanded state. Suitable layer thicknesses D of the marker sleeve 10 in the relaxed state range from about 0.76 millimeters (mm) (30 mils) to about 2.29 mm (90 mils). Particularly suitable layer thicknesses D of the marker sleeve 10 in the relaxed state range from about 1.27 mm (50 mils) to about 1.78 mm (70 mils).

After the marker sleeve 10 is formed, the marker sleeve 10 is cross-sectionally expanded from the relaxed state to the expanded state. Herein, the terms “expanded”, “expansion”, “expanded state”, and the like, refer to a cross-sectional expansion that increases the inner diameter B and the outer diameter C, as opposed to a longitudinal expansion that would increase the longitudinal length A. Referring to FIG. 3, which depicts the marker sleeve 10 of FIG. 2 in the expanded state around a core 22, the marker sleeve 10 may be expanded and placed onto the core 22 in any conventional manner. The core 22 may be any type of rigid device for retaining the marker sleeve 10 in the expanded state, such as a rigid, hollow, plastic tube. When the marker sleeve 10 is in the expanded state, as depicted in FIG. 3, the radial wall 11 includes a longitudinal length A′, an inner diameter B′, an outer diameter C′, and a layer thickness D′. Due to the expansion, the inner diameter B′ and the outer diameter C′ are greater than the inner diameter B and outer diameter C, respectively. The extent of the diameter increases from B to B′ and from C to C′ depend on the extent to which the marker sleeve 10 is expanded. Suitable expansion of the marker sleeve 10 generally include increases from the inner diameter B to the inner diameter B′ that range from about 150% to about 300%. Particularly suitable expansion ranges of the marker sleeve 10 include increases from the inner diameter B to the inner diameter B′ that range from about 200% to about 250%.

The expansion of the marker sleeve 10 also causes the layer thickness D′ to be thinner than the layer thickness D. The extent of the difference between the layer thickness D and the layer thickness D′ depends on the particular composition of the marker sleeve 10 and the extent to which the marker sleeve 10 is expanded. As previously discussed, the layer thickness D′ of the marker sleeve 10, in the expanded state, should be thick enough to prevent the laser marking from burning entirely through the radial wall 11 of the marker sleeve 10. The expansion of the marker sleeve 10 also typically causes the longitudinal length A′ of the expanded marker sleeve 10 to be shorter than the longitudinal length A of the marker sleeve 10 in the relaxed state.

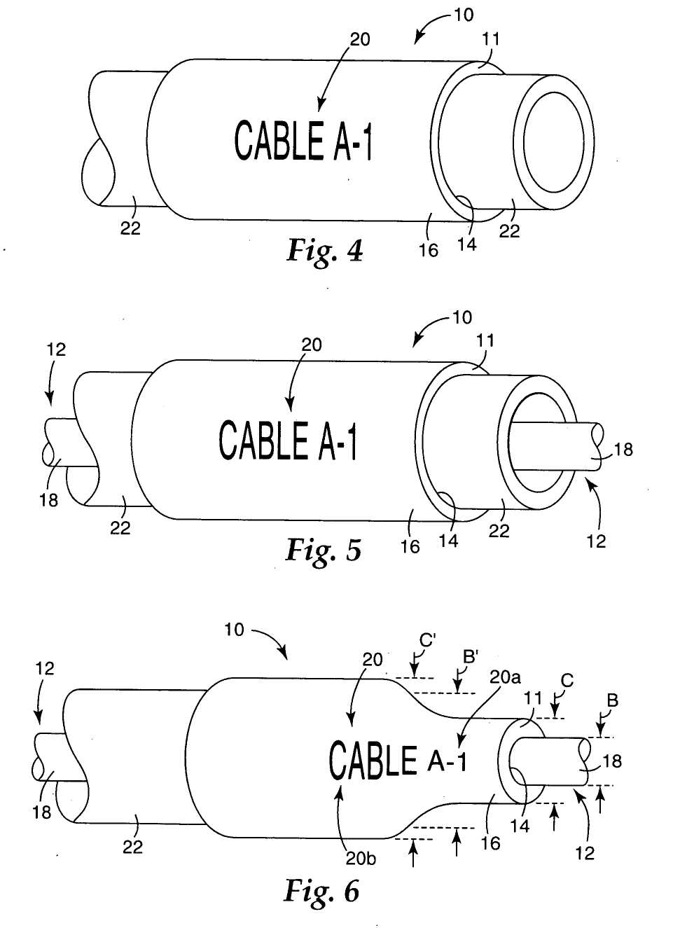

FIG. 4 is a perspective view of the marker sleeve 10 in the expanded state and on the core 22, after the outer surface 16 is marked to form the indicia 20. Marking of the outer surface 16 while the marker sleeve 10 is in the expanded state increases the surface area of the marked portion of the outer surface 16. As such, larger indicia 20 may be formed. The size differences of the indicia 20 are best illustrated by comparing the indicia 20 depicted in FIGS. 1 and 4. The indicia 20 depicted in FIG. 4, where the marker sleeve 10 is in the expanded state, exhibits taller, narrower type face heights in the circumferential direction of the marker sleeve 10 than the indicia 20 depicted in FIG. 1, where the marker sleeve 10 is in the relaxed state. Laser marking the marker sleeve 10 in the relaxed state would increase the required accuracy and consistency to create visibly legible indicia. As such, the expansion of the marker sleeve 10 prior to marking allows formation of indicia 20 that exhibit a higher degree of detail and resolution, and thereby reduces the marking precision required to produce the indicia 20 that is highly legible when the marker sleeve 10 is in the relaxed state.

The indicia 20 is formed by marking the outer surface 16 of the marker sleeve 10 with a focused energy beam, such as a laser beam. In one embodiment, the indicia 20 may be formed by exposing the outer surface 16 of the marker sleeve 10 to laser generated radiation (i.e., a laser beam) at an energy level sufficient to cause charring of selected portions of the outer surface 16. The charring is created when the heat of the focused energy beam transfers from the energy beam absorber to initiate a chemical reaction of the polymers. The chemical reaction alters the color of the outer surface 16 at the location of the charring, which creates a dark contrasting mark that visibly contrasts with the remaining lighter base colored portions of the outer surface 16.

Alternatively, in a second embodiment, different laser beam settings may be used to foam the outer surface 16 in the course of forming the indicia 20. This is useful to create light-colored markings on the outer surface 16. The foaming, like the aforementioned charring, is also created by a chemical reaction of the polymers upon heating with a focused energy beam. However, the chemical reaction creates a light-colored mark at the location of the foaming, which visibly contrasts with the remaining dark-colored portions of the outer surface 16. In either embodiment, the focused energy beam is moved about the outer surface 16 as needed to create the desired textual characters, graphics, symbols, and the like, of the indicia 20.

An example of a suitable laser system for creating such markings in the outer surface 16 of the radial wall 11 is a Nd:YAG laser, which is commercially available under the trade designation “Scriba” from Electrox of Indianapolis, Indiana. However, other focused energy beam systems may also be employed, such as CO₂ lasers and masers. The indicia 20 may be made in one or two passes of the laser beam, or in additional passes of the laser beam if a somewhat wider field of the indicia 20 is desired. Multiple laser beam passes may also be used, either from multiple lasers or via laser beam splitting and focusing techniques. Suitable set distances of the laser system head to the outer surface 16 of the marker sleeve 10 include ranges from about 2 centimeters (cm) to about 31 cm. Such ranges are generally determined by the laser focus point of the system. For example, an Nd:YAG laser system may exhibit a set distance of the laser system head to the outer surface 16 of the marker sleeve 10 of 18.3 cm (7.2 inches).

The settings of the laser system are selected so the marker sleeve 10 is adequately marked on the outer surface 16 (i.e., to prevent under-marking), but without excessively heating or softening (i.e., to prevent over-marking) underlying portions of the marker sleeve 10. It is important that the structural integrity of the radial wall 11 of the marker sleeve 10 is maintained to avoid the potential for tearing the radial wall 11. The laser beam energy pulses should not adversely affect the ability of the marker sleeve 10 to be securely retained on the cable 12. Examples of suitable settings for a Nd:YAG laser system include power settings ranging from about 55 watts to about 70 watts, rates of marking ranging from about 5 cm/minute to about 7 cm/minute, and frequencies ranging from about 1 wave peak per second to about 10 wave peaks per second.

Laser marking enables significant flexibility for production of identification markings (i.e., indicia 20), both in terms of the information being marked, and in terms of production lead times and set up costs. The flexibility of laser marking allows individualized tailoring of the indicia 20 on the marker sleeve 10 to specific customer requests, or specific marketing goals. The laser markings may be easily and quickly changed from one marker sleeve 10 to a different marker sleeve 10. For example, digital information regarding markings desired by a customer may be input into a computer program, which directs the laser system to produce the laser markings. This allows for quick start-ups and on-demand modifications to the laser markings.

After marking, the marker sleeve 10 with the indicia 20 is removed from the core 22 onto the cable 12. This may be accomplished by any suitable conventional technique. In one embodiment, as depicted in FIGS. 5 and 6, the cable 12 may be inserted within the hollow portion of the core 22, before or after laser marking. The cable 12 may be cross-sectionally centered within the core 22 by guide fingers (not shown) contained within the core 22. After the cable 12 is inserted within the core 22, the marker sleeve 10 is conveyed from the core 22 onto the cable 12. The conveyance may be accomplished in a variety of manners, such as by sliding the marker sleeve 10 from the core 22 onto the cable 12, or by collapsing and removing the core 22 to allow the marker sleeve 10 to encompass the cable 12.

As depicted in FIG. 6, when the marker sleeve 10 is removed from the core 22, the marker sleeve 10 cold shrinks from the expanded state toward the relaxed state. Whether or not the marker sleeve 10 reaches the relaxed state depends on the diameter of the cable 12. As depicted in FIG. 6, the cable 12 has a diameter that allows the marker sleeve 10 to substantially return to the relaxed state, as noted by the inner diameter B and the outer diameter C. Alternatively, however, the inner diameter B of the marker sleeve 10 in the relaxed state may be slightly smaller than the diameter of the cable 12. This alternative prevents the marker sleeve 10 from fully cold shrinking back to the relaxed state, and thereby provides a snug and secure fit of the marker sleeve 10 around the cable 12.

The cross-sectional shrinkage of the marker sleeve 10 also shrinks the indicia 20, as shown by comparing indicia portions 20a, 20b. When a portion of the marker sleeve 10 shrinks, the corresponding portion of indicia 20 (i.e., the indicia portion 20a) also shrinks, while the portion of indicia 20 that remains in the expanded state supported on the core 22 (i.e., the indicia portion 20b) remains larger. When the marker sleeve 10 shrinks, the indicia portion 20a retracts with the cross-sectional dimensions that decrease from the inner diameter B′ and the outer diameter C′. However, the retraction of the indicia portion 20a and consequent reduction of the dimensions of the indicia 20 does not render the indicia 20 illegible. For example, a portion of the indicia 20 that is defined by a straight line when the marker sleeve 10 is in the expanded state will remain defined by a straight line when the marker sleeve 10 substantially cold shrinks back toward the relaxed state. Moreover, the reduction of the dimensions of the indicia 20 effectively increases the print density of the indicia 20. As such, the indicia portion 20a remains visually legible when the marker sleeve 10 is substantially in the relaxed state, to provide information regarding the cable 12.

The marker sleeve 10 desirably provides information markings (i.e., indicia 20) that conform to the U.S. Department of Defense Standard Practice MIL-STD-130K (2000), entitled “Identification Marking of U.S. Military Property”, and the SAE AS81531 Aerospace Standard of SAE International, Warrendale, Pennsylvania, entitled “Marking of Electrical Insulating Materials”, each of which is incorporated herein by reference in its entirety. The SAE AS81531 Aerospace Standard §3.2.2 provides examples of suitable type face heights in the circumferential direction of the marker sleeve 10 in the relaxed state, which include type-face heights ranging from about 1.6 mm for an outer diameter C of about 0.9 mm to about 4.5 mm for an outer diameter C of about 25 mm.

Upon complete removal from the core 22, the marker sleeve 10 cold shrinks around the cable 12, as depicted in FIG. 1. The indicia 20 located on the outer surface 16 sufficiently contrasts in color with the outer surface 16 to enable visual human detection of the indicia 20 and/or optical machine-readable detection of the indicia 20. The indicia 20 will also retain the visual legibility while the marker sleeve 10 is exposed to NBC agents.

### Property Analysis and Characterization Procedures

Various analytical techniques are available for characterizing the sealant materials of the present invention. Several of the analytical techniques are employed herein. An explanation of these analytical techniques follows.

### NBC Test

A series of quantitative and qualitative tests relating to the Nuclear, Biological, and Chemical Contamination Survivability (NBCCS) requirement were performed to evaluate the chemical survivability of the compositions of the present invention. Samples tested included slabs of the composition of the present invention and corresponding marker sleeves extending around cables. The marker sleeves were created by extruding the composition of the present invention and cross-linking, as described above.

The testing was conducted by Calspan-UB Research Center, Inc., Buffalo, N.Y., according to Test Operation Procedure (TOP) 8-2-111, entitled “Nuclear, Biological, and Chemical (NBC) Contamination Survivability, Small Items of Equipment”, dated 24 Apr. 1998. The testing was performed sequentially and included desorption and contact hazard measurements on the composition samples, and functional performance evaluations on the marker sleeves.

### Physical Property Tests

Physical properties regarding the tension modulus (100%, 200%, and 300%), tensile strength at break, percent elongation at break, shore A hardness, and percent permanent set of the marker sleeves were quantitatively measured to illustrate the elasticity and durability of the marker sleeves of the present invention. The tension modulus (100%, 200%, and 300%), tensile strength at break, and percent elongation at break tests were performed pursuant to ASTM D412-92. The shore A hardness test was performed pursuant to ASTM D2240-03.

The percent permanent set test illustrates the amount of elastic recovery a material exhibits. For different compositional mixtures of the marker sleeve, a dogbone sample was formed with an ASTM D412-92 Die C Dumbbell Cutter, with an original length of 2.54 cm. The sample was then placed in a tension set fixture and stretched longitudinally to 200% of the original length (i.e., 100% strain). This length (i.e., 5.08 cm) was recorded as the test length. The stretched sample was then retained in the stretched dimension and subjected to a temperature of 100° C. for three hours. The stretched sample was then cooled for one hour at a temperature of 21° C. After cooling, the stretched sample was removed from the tension set fixture allowed to cold shrink for 30 minutes at room temperature. The relaxed length was then measured. The percent permanent set was calculated by the following equation:

$$\% PermanentSet = \frac{100 \times ( RelaxedLength - OriginalLength )}{( TestLength - OriginalLength )}$$

### Laser Marking Test

The visual legibility of the indicia was qualitatively determined for marker sleeves formed from the compositions of the present invention pursuant to the following procedure. A marker sleeve without indicia was expanded onto a core with a 3.5 cm diameter. The expanded marker sleeve was then laser marked to form indicia by a Nd:YAG laser system. The Nd:YAG laser system was commercially availably under the trade name “Hi-Mark” No. 400 from GSI Lumonics, Inc. of Kanata, Ontario, Canada. The laser settings for the Nd:YAG laser system included a power setting of 64.8 watts, a rate of marking 5.1 cm/minute, and a frequency of 6 wave peaks per second. The set distance of the laser system head to the outer surface of the marker sleeve was 18.3 cm (7.2 inches). The indicia was marked so that, in the relaxed state, the indicia exhibited a type-face height in a circumferential direction of the marker sleeve of 2.0 mm.

After marking, the marker sleeve was removed from the core and allowed to substantially cold shrink back toward the relaxed state. The indicia on the marker sleeve substantially in the relaxed state was then visually observed by an unaided human eye. The marking was determined to be acceptable if the indicia (exhibiting a type-face height of 2.0 mm) on the marker sleeve was visually legible by an unaided human eye (i.e., about 20/20 vision) from a distance of at least about 36 cm (about 14 inches).

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

The following compositional abbreviations are used in the following Examples:
“Buna EPT 6850”: A terpolymer of an ethylene-propylene-diene monomer, commercially available from Bayer Chemical Corporation of Leverkusen, Germany.
“Buna EPT 8902”: An oil-extended 50% terpolymer of an ethylene-propylene-diene monomer, commercially available from Bayer Chemical Corporation of Leverkusen, Germany.
“Vanox ZMTI”: An antioxidant derived from a 50% dispersion of zinc 2-mercaptotoluimidazole in a petroleum process oil, commercially available from R.T. Vanderbilt Company, Inc. of Norwalk, Conn.
“Stantone MBYellow”: A 50% dispersion of an azoic pigment CI pigment yellow 83 in ethylene-propylene rubber, commercially available under the trade designation “Stantone MB 11070 Yellow” from PolyOne Corporation of Suwanee, Ga.
“Struktol EF-44 A”: A processing aid mixture of a fatty acid metal soap and an amide, commercially available from Struktol Company of America of Stow, Ohio.
“Rheogran ZnO-85”A solution of 85% active zinc oxide dispersion in mineral oil, commercially available from Rhein Chemie Rheinau GmbH of Mannheim, Germany.
“Translink 37”: Silane treated kaolin clay (aluminum silicate) with a particle size of 1.4 micrometers, commercially available from Engelhard Corporation of Iselin, N.J.
“Hisil 532 EP”: Hydrated amorphous silica filler commercially available from PPG Industries, Inc. of Pittsburgh, Pa.
“Saytex BT-93 W”: A flame retardant derived from 1,2 bis(tetrabromophthalimide) ethane, commercially available from Albemarle Corporation of Houston, Tex.
“Sunpar 2280”: A parafinnic petroleum oil commercially available from Sunoco, Inc. of Philadelphia, Pa.
“Zinc Omadine”: A fungicide solution of 65% 2-pyridinethiol-1-oxide, zinc complex in a paraffinic oil (i.e., Zinc Omadine), commercially available from Arch Chemicals, Inc. of Cheshire, Conn.
“Nycol Burn EX ZTA”: Sodium antimonite commercially available from Nyacol Nano Technologies, Inc. of Ashland, Mass.
“Tipure 902”: Titanium dioxide commercially available from E.I. Du Pont Corporation of Wilmington, Del.
“A-172 DLC”: A silane coupling agent derived from vinyl-tris(2-methoxyethoxy) silane, commercially available from Natrochem, Inc. of Savannah, Ga.
“PolyOne Material”: A laser additive derived from Stan-Tone MB-27838 Black, designated as “PolyOne Material #AD 3000051160”, available from PolyOne Corporation of Suwanee, Ga.
“Varox 802-40KE”: A peroxide cross-linking agent derived from a solution of 40% active di(2-tert-butylperoxyisopropyl) benzene supported on a silane modified clay, commercially available from R.T. Vanderbilt Company, Inc. of Norwalk, Conn.
“SR-297 Methacrylate”: An acrylic co-agent derived from 1,3 butyleneglycol-dimethacrylate, commercially available under the trade designation “SR-297”from Sartomer Company, Inc. of Exton, Pa.

### Example 1

Example 1 concerns a composition of the present invention. Table 1 provides the component concentrations of the composition of Example 1. The composition of Example 1 was prepared by combining the components provided in Table 1 (except the Varox 802-40KE peroxide and the SR-297 methacrylate) in a first mixing step, and then mixing these components in a 10D 2-wing tangential Banbury mixer with a 220 liter capacity at 50 rotations-per-minute for eight minutes at temperature of 141° C. The compositional mixture was then be passed through a 25.4-cm extruder equipped with a 100 mesh screen to remove undispersed particles.

The Varox 802-40KE peroxide and the SR-297 methacrylate were then added in a second mixing step and the overall compositional mixture was mixed in a 10D 2-wing tangential Banbury mixer with a 220 liter capacity at about 45 rotations-per-minute for 3 minutes at temperature of 102° C.

The marker sleeve of Example 1 was formed from the compositional mixture by extruding the compositional mixture through a 5.1-cm single-screw extruder having a length-to-diameter ratio of 15, extruder zone and die temperatures of 80° C., and a rotation rate of 30 rotations-per-minute. Upon exiting the extruder, the marker sleeve was cross linked by passing the extruded article through an autoclave, having a steam pressure of 620 kilopascals, for 45 minutes.

TABLE 1

| | Percent by |
|---|---|
| Component | Weight* |
| Buna EPT 6850 | 21.7 |
| Buna EPT 8902 | 18.6 |
| Vanox ZMTI | 0.6 |
| Stantone MB Yellow | 1.9 |
| Structol EF-44 A | 0.6 |
| Rheogran ZnO-85 | 1.2 |
| Translink 37 | 6.2 |
| Hisil 532 EP | 12.4 |
| Saytex BT-93 W | 14.9 |
| Sunpar 2280 | 12.4 |
| Zinc Omadine | 0.2 |
| Nycol Burn EX ZTA | 2.5 |
| Tipure 902 | 3.1 |
| A-172 DLC | 0.3 |
| Varox 802-40KE | 2.2 |
| SR 297 Methacrylate | 1.2 |

*Based on the total weight of the compositional mixture of Example 1.

### Example 2

Example 2 concerns a composition of Example 1, which additionally includes the laser additive Stan-Tone MB-27838 Black (i.e., PolyOne Material #AD 3000051160) in the composition (added in the first mixing step). Table 2 provides the component concentrations of the composition of Example 2. Marker sleeves were formed from the composition of Example 2 pursuant to the procedure described for the marker sleeves of Example 1.

TABLE 2

| | Percent by |
|---|---|
| Component | Weight* |
| Buna EPT 6850 | 22.4 |
| Buna EPT 8902 | 19.2 |
| Vanox ZMTI | 0.6 |
| Stantone MB Yellow | 1.9 |
| Structol EF-44 A | 0.6 |
| Rheogran ZnO-85 | 1.3 |
| Translink 37 | 6.4 |
| Hisil 532 EP | 12.8 |
| Saytex BT-93 W | 15.4 |
| Sunpar 2280 | 12.8 |
| Zinc Omadine | 0.2 |
| Nycol Burn EX ZTA | 2.6 |
| A-172 DLC | 0.3 |
| PolyOne Material | 0.1 |
| Varox 802-40KE | 2.2 |
| SR 297 Methacrylate | 1.2 |

*Based on the total weight of the compositional mixture of Example 2.

### Example 3

Example 3 concerns a composition of Example 2, which additionally includes Tipure 902 titanium dioxide in the composition (added in the first mixing step). Table 3 provides the component concentrations of the composition of Example 3. Marker sleeves were formed from the composition of Example 3 pursuant to the procedure described for the marker sleeves of Example 1.

TABLE 3

| | Percent by |
|---|---|
| Component | Weight* |
| Buna EPT 6850 | 21.7 |
| Buna EPT 8902 | 18.6 |
| Vanox ZMTI | 0.6 |
| Stantone MB Yellow | 1.9 |
| Structol EF-44 A | 0.6 |
| Rheogran ZnO-85 | 1.2 |
| Translink 37 | 6.2 |
| Hisil 532 EP | 12.4 |
| Saytex BT-93 W | 14.9 |
| Sunpar 2280 | 12.4 |
| Zinc Omadine | 0.2 |
| Nycol Burn EX ZTA | 2.5 |
| Tipure 902 | 3.1 |
| A-172 DLC | 0.3 |
| PolyOne Material | 0.1 |
| Varox 802-40 KE | 2.2 |
| SR 297 Methacrylate | 1.2 |

*Based on the total weight of the compositional mixture of Example 3.

NBC Tests for Examples 1-3

The compositions of Examples 1-3 and marker sleeves created from the compositions of Examples 1-3 were subjected to the NBCCS testing pursuant to the “NBC Test” procedure described above. The compositions of Examples 1-3 and marker sleeves created from the compositions of Examples 1-3 were met the NBCCS requirements. This is believed to be due to the combination of the EPDM rubber, the flame retardant, and the antimicrobial agent. As such, the compositions of Examples 1-3 are NBC resistant and may be used to create articles that may be used in hazardous environment containing NBC agents.

Physical Property Tests for Examples 1-3

The marker sleeves of Examples 1-3 were tested pursuant to the “Physical Properties Tests” procedures described above. Table 4 provides the results of the physical property tests for marker sleeves created from the compositions of Examples 1-3. The tension modulus (100%, 200%, and 300%) and tensile strength at break have metric units of megaNewton per square meter (MN/m²) (i.e., 1×10⁶ Newtons per square meter).

TABLE 4

| Physical Property | Example 1 | Example 3 | Example 2 |
|---|---|---|---|
| 100% Modulus (MN/m²) | 1.13 | 1.05 | 1.21 |
| 200% Modulus (MN/m²) | 1.74 | 1.59 | 1.91 |
| 300% Modulus (MN/m²) | 2.31 | 2.11 | 2.48 |
| Tensile Strength at Break (MN/m²) | 6.14 | 5.13 | 6.20 |
| % Elongation at Break | 717 | 715 | 732 |
| Shore A Hardness | 52.0 | 50.0 | 52.0 |
| % Permanent Set | 16.2 | 16.0 | 16.5 |

The data provided in Table 4 illustrates the expansion capabilities and durability of articles (i.e., marker sleeves) created from the compositions of Examples 1-3. The marker sleeves of Examples 1-3 exhibited 100% tension moduli from 1.05 MN/m² to 1.21 MN/m², 200% tension moduli from 1.59 MN/m² to 1.91 MN/m², and 300% tension moduli from 2.11 MN/m² to 2.48 MN/m². The marker sleeves of Examples 1-3 exhibited tensile strengths at break from 5.13 MN/m² to 6.20 MN/m² with percent elongations at break from 715% to 732%. The marker sleeves of Examples 1-3 also exhibited shore A hardnesses of about 50.

The marker sleeves of Examples 1-3 also exhibited percent permanent sets of about 16%. As such, when subjected to the percent permanent set test, as described above, the marker sleeves of Examples 1-3 are capable of cold shrinking back about 84% to about 90% from the expanded state dimensions.

Laser Marking Test for Examples 1-3

The marker sleeves of Examples 1-3 were tested according to the “Laser Marking Test” procedure described above. After the marker sleeves of Examples 1-3 had substantially cold shrunk back toward the relaxed state, the indicia on each of the marker sleeves remained visually legible to an unaided human eye from at least 36 cm (about 14 inches). This illustrates the benefit of marking the indicia on the marker sleeves of the present invention in an expanded state. When marking the indicia while the marker sleeves are in an expanded state, a higher degree of detail and resolution of the indicia is obtained, which thereby reduces the marking precision required to produce the indicia. The resulting indicia remain visually legible when the marker sleeves substantially cold shrink to the relaxed state.

Although the present invention has been described with reference to preferred embodiments, workers skilled in the art will recognize that changes may be made in form and detail without departing from the spirit and scope of the invention.

1. A composition comprising:
a terpolymer of an ethylene-propylene-diene monomer;
a flame retardant; and
an antimicrobial agent.

2. The composition of claim 1 further comprising a flame retardant synergist.

3. The composition of claim 1, wherein the flame retardant comprises 1,2 bis(tetrabromophthalimide) ethane.

4. The composition of claim 1, wherein the antimicrobial agent comprises a salt complex of pyrithione.

5. The composition of claim 1, wherein:
the terpolymer of the ethylene-propylene-diene monomer constitutes about 30.0% to about 80.0% by weight of the composition;
the flame retardant constitutes about 10.0% to about 30.0% by weight of the composition; and
the antimicrobial agent constitutes about 0.1% to about 0.4% by weight of the composition.

6. The composition of claim 1 further comprising filler material selected from silica, clay, and combinations thereof.

7. The composition of claim 6 further comprising a silane coupling agent.

8. The composition of claim 1 further comprising a peroxide.

9. The composition of claim 8 further comprising an acrylic co-agent.

10. The composition of claim 8 further comprising zinc oxide.

11. A composition of claim 1 further comprising:
a flame retardant synergist;
an antioxidant; and
hydrocarbon oil.

12. The composition of claim 11, wherein the flame retardant comprises 1,2 bis(tetrabromophthalimide) ethane.

13. The composition of claim 11, wherein the antimicrobial agent comprises a salt complex of pyrithione.

14. The composition of claim 11, wherein:
the terpolymer of the ethylene-propylene-diene monomer constitutes about 30.0% to about 80.0% by weight of the composition;
the flame retardant constitutes about 10.0% to about 30.0% by weight of the composition;
the flame retardant synergist constitutes about 1.0% to about 4.0% by weight of the composition;
the antimicrobial agent constitutes about 0.1% to about 0.4% by weight of the composition;
the antioxidant constitutes about 0.5% to about 2.0% by weight of the composition; and
the hydrocarbon oil constitutes about 10.0% to about 25.0% by weight of the composition, based on the total weight of the composition.

15. The composition of claim 11 further comprising filler material selected from silica, clay, and combinations thereof.

16. The composition of claim 15 further comprising a silane coupling agent.

17. The composition of claim 11 further comprising a peroxide.

18. The composition of claim 17 further comprising an acrylic co-agent.

19. The composition of claim 17 further comprising zinc oxide.

20. The composition of claim 11 further comprising a pigment and an energy beam absorber.

21. The composition of claim 20, wherein the energy beam absorber comprises a laser beam absorber.

22. An article having a surface, the article comprising:
a mixture of a terpolymer of an ethylene-propylene-diene monomer, a flame retardant, an antimicrobial agent, a pigment, and an energy beam absorber; and
focused energy beam-induced indicia located on the surface.

23. The article of claim 22, wherein the article comprises a tubular article, and wherein the surface comprises an outer surface.

24. The article of claim 22 further comprising a flame retardant synergist.

25. The article of claim 24, wherein the flame retardant comprises 1,2 bis(tetrabromophthalimide) ethane.

26. The article of claim 24, wherein the antimicrobial agent comprises a salt complex of pyrithione.

27. The article of claim 22, wherein the focused energy beam comprises a laser, and wherein the energy beam absorber comprises a laser beam absorber.

28. A tubular article in an expanded state having an outer surface, the tubular article comprising:
a mixture comprising a terpolymer of an ethylene-propylene-diene monomer, a flame retardant, an antimicrobial agent, a pigment, and an energy beam absorber; and
focused energy beam-induced indicia located on the outer surface, wherein the tubular article is capable of being placed in a relaxed state, and wherein the indicia is legible to an unaided eye of an individual with 20/20 vision located at least about 32 centimeters away from the indicia when the tubular article is in the expanded state and when the tubular article is in the relaxed state.

29. The article of claim 28 further comprising a flame retardant synergist.

30. The article of claim 28, wherein the energy beam absorber comprises a laser beam absorber.

31. A method of marking a tubular article having an outer surface, the method comprising:
providing the tubular article, the tubular article comprising a terpolymer of an ethylene-propylene-diene monomer, a flame retardant, an antimicrobial agent, a pigment, and an energy beam absorber;
expanding the tubular article from a relaxed state to an expanded state;
forming indicia on the outer surface with a focused energy beam; and
allowing the tubular article to cold shrink from the expanded state.

32. The method of claim 31, wherein providing the tubular article comprises extruding and cross-linking a mixture that comprises the terpolymer of the ethylene-propylene-diene monomer, the flame retardant, the antimicrobial agent, the pigment, and the energy beam absorber to form the tubular article.

33. The method of claim 31, wherein the focused energy beam comprises a laser beam.
